(19) United States
(12) Patent Application Publication
(10) Pub. No.: US 2010/0143502 A1
(43) Pub. Date: Jun. 10, 2010

(54) PLANT WASH

(76) Inventor: Roger Rolland Ellis, Tieton, WA (US)

Correspondence Address: HAYES SOLOWAY P.C., 3450 E. SUNRISE DRIVE, SUITE 140, TUCSON, AZ, 85718, US

(21) Appl. No.: 12/624,198

(22) Filed: Nov. 23, 2009

Related U.S. Application Data
(60) Provisional application No. 61/121,102, filed on Dec. 9, 2008.

(51) Int. Cl. A01N 59/06; A01N 65/00; A01N 65/03; A01N 65/20; A01P 1/00

(52) U.S. Cl. 424/688; 424/725; 424/757; 424/195.17

(57) ABSTRACT

A plant wash comprising a mixture of dormant oil and hop extract in a carrier is useful for protecting fruit trees against freeze damage, bacterium, pest infestations, fungi and wilt.

### CROSS REFERENCE TO RELATED APPLICATION

This application claims priority from U.S. Provisional Application Ser. No. 61/121,102 filed Dec. 9, 2008.

### FIELD OF THE INVENTION

The present invention relates to a plant wash. The invention has particular utility as a tree wash for fruit trees for protection against freeze damage, or for protection against bacterium such as Fire Blight, or for protection against Codling Moth, Leafroller, Pear Psylla, White Apple Leafhopper, Green Apple Aphid and Wooley Apple Aphid infestations, or protection from fungi such as powdery mildew, downy mildew, Cladosporium Cucumerinum (Gamosis) and wilt. Application as a wash throughout the growing season also promotes early ripening for harvested fruit and vegetables. The plant wash of the present invention also may be used as a wash for harvested fruit and vegetables for preventing growth of mold and bacterium during storage.

### BACKGROUND OF THE INVENTION

Hops are primarily used in the brewing of beer. It is known that compounds derived from flowers of the female hop plant (Humulus lupulus L.) contribute a desirable bitter flavor to beer. This bitterness derives from the so-called α-acids, an homologous series of organic acids that are converted during the boiling of the brewer's wort into highly bitter, isomerized α-acids (iso-α-acids). Hops also contain an analogous series of β-acids. These substances, which have very low aqueous solubility, are of little value in brewing and are almost entirely eliminated from the wort by precipitation in the proteinaceous “trub” that forms during the boil. Many brewers now use extracts of hops which are convenient and much more stable that the traditional dried hops. Such products are made by extracting the hops with organic solvent (almost exclusively ethanol) or, more commonly, with carbon dioxide in either liquid or supercritical state. These extracts contain high contents of α-acids and β-acids, most of the remainder consisting of hop oils, waxes and uncharacterized resins. Typically, the α-acids content of a hop extract is in the range 35-65% by weight, that of the β-acids 15-40%. Hop processing companies have for many years also offered brewers a choice of more refined products that are prepared from the hop extracts by means of fractionation and chemical conversion, many of which may be added into the brewing process after fermentation of the wort. Such products include aqueous preparations of purified iso-α-acids, and their chemically reduced derivatives, especially tetrahydroiso-α-acids. In the course of preparation of these products, the hop processor will typically obtain a by-product fraction that comprises primarily a mixture of β-acids and hop oils, plus some minor components including waxes and small amounts of iso-α-acids. This fraction, commonly known as “β-Fraction” “Beta Aroma Extract” or “Base Extract” is often sold to brewers for addition to the wort kettle, where the hop oil component imparts aromatic flavors. However, it is also common to separate the oils from the β-acids, enabling a more potent “Aroma Extract” to be offered and releasing the β-acids for other uses.

In addition to being used for the purpose of contributing bitter and aromatic flavors to beer, hops are known to be useful to control bacterial growth during the brewing process. It has been demonstrated that the hop resin acids (α-acids, β-acids, iso-α-acids and chemically reduced iso-α-acids such as tetrahydroiso-α-acids) have anti-microbial activity and are especially active against Gram positive bacteria. Consequently, several uses for hop resin acids in food processing, cosmetic and pharmaceutical applications have been described. β-acids are generally considered to be particularly effective, natural antibacterial agents. In WO 00/52212 it is noted that “certain hop acids exhibit anti-bacterial effects in sugar containing aqueous mediums. European Patent Application No. 681 029 A2 discloses a process for inhibiting thermophilic micro-organisms in the presence of sucrose aqueous medium, in which a hop based product is added to a sucrose aqueous medium at temperatures between 50° C. and 80° C. And, U.S. Pat. No. 5,286,506 discloses a process of applying a solution containing beta acids to a solid food product to prevent growth of Listeria. According to Arch. Mikrobiol. 94 (1973), p. 159-171 beta acids exhibit the highest bacteriostatic effect in comparison to alpha acids and isoalpha acids; however, because of its poor solubility, certain concentrations of beta-acids cannot be exceeded.” Hop resin acids, especially β-acids, have also been described as effective antibacterial agents in food processing in US Provisional Patent No. 2002/0197366, U.S. Pat. No. 6,251,461 and U.S. Pat. No. 6,475,537, and have recently also been shown to have useful activity against algal growth in water systems (U.S. Pat. No. 6,379,720 and PCT Application No. WO 02/078450), protozoa (U.S. Pat. No. 6,352,726 and U.S. Pat. No. 6,423,317) and have been proposed as active agents against mastitis in cows, wherein the hop compound can be applied to the udders and teats of cows (US Patent Application No. 2003/0013773. The possibility to use hop acids in mouthwashes or toothpastes to suppress the activity of Streptococcus mutans and thus help to prevent caries has been described in U.S. Pat. No. 5,370,863. The general mechanism by which hop acids are believed to act against susceptible (Gram+ve) bacteria has been discussed by Simpson and Smith (Simpson, W. J., and Smith, A. R. W., 1992 in “Factors affecting antimicrobial activity of hop compounds and their derivatives”. The Journal of Applied Bacteriology 72 (4):327-334).

Other beneficial applications have been found for hops extract generally and β-acids specifically. For example, U.S. Application No. 2005/0220914 describes an organic pesticide made from components of hop extract. The hops extract is suspended in colloidal emulsions in water and are used as a pesticide spray for pests such as spider mites, powdery mildews, downy mildews and late blights.

### SUMMARY OF THE INVENTION

The present invention is based on the discovery that hop extract when combined with dormant oil, provides a number of interesting and beneficial effects when sprayed on plants, in particular fruit trees and other crops that experience damage from freeze damage, bacterium, pests and fungi. Observed effects include protection against freeze damage, protection against bacterium such as Fire Blight, protection against Codling Moth, Leafroller, Pear Psylla, White Apple Leafhopper, Green Apple Aphid and Wooley Apple Aphid infestations, and protection against fungi such as powdery mildew, downy mildew Cladosporium Cucumerinum (Gamosis) and wilt. Application as a wash throughout the growing season also results in an increase in the sugar Brix in fruit allowing earlier harvest of fruit. The plant wash of the present invention also may be used as a wash for harvested fruit and vegetables for preventing growth of mold and bacterium during storage.

### BRIEF DESCRIPTION OF THE DRAWINGS

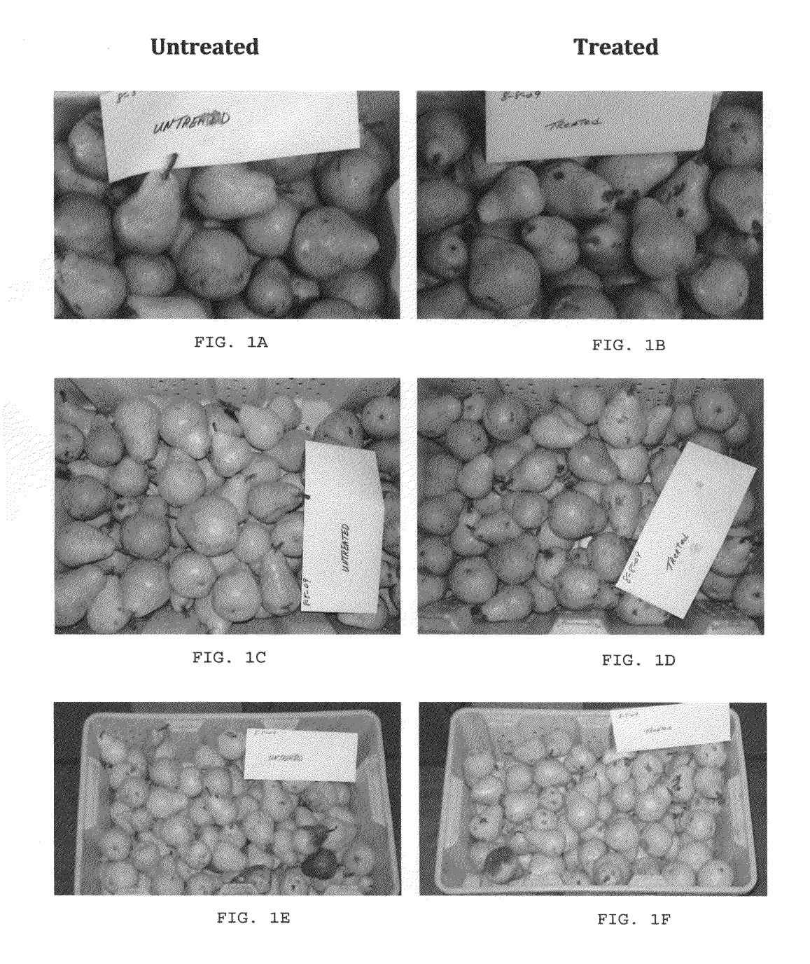

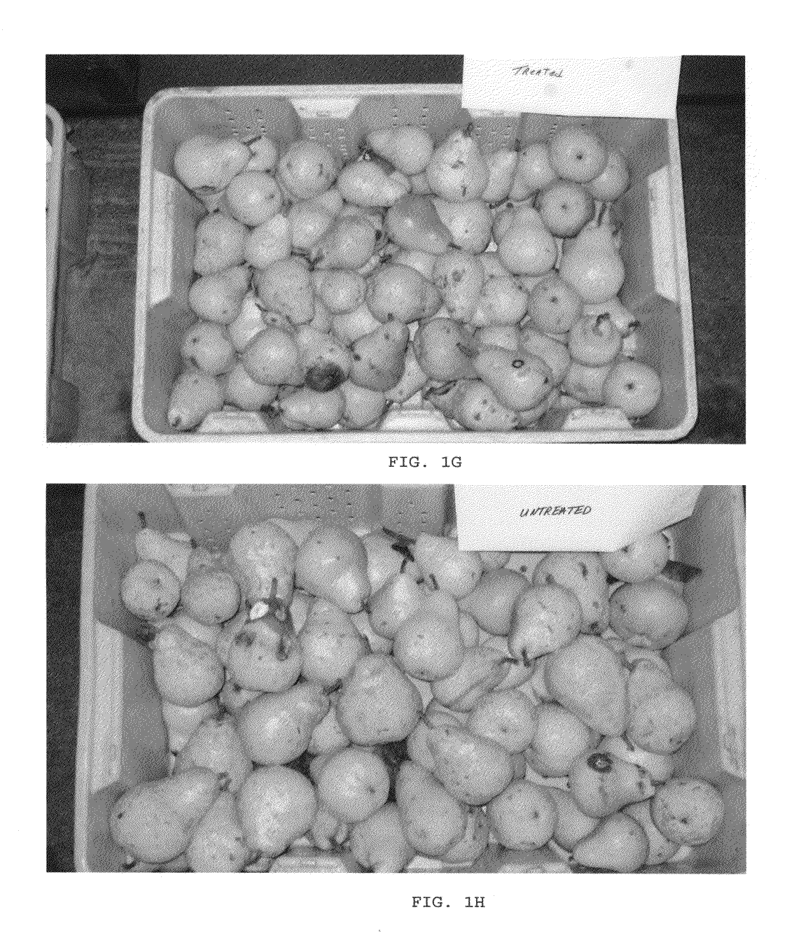

Further features and advantages of the present invention will be seen from the following detailed description, taken in conjunction in the accompanying drawings, wherein FIGS. 1A-1H are photographs showing condition of treated and untreated pears in storage, over time.

### DETAILED DESCRIPTION OF THE INVENTION

The present invention employs a mixture or blend of hop extract mixed with dormant oil and optionally including one or more other ingredients in spray or both. More particularly, I have found that an oily spray of water, dormant oil and hop extract and optionally including one or more additional ingredients, when applied as a wash to fruit trees or vegetable plants, or as a wash for harvested fruit and vegetables produces several advantageous affects.

Dormant oil spray has been used for many years for pest control on fruit trees. Dormant oil sprays work by suffocating certain over-wintering pests. Various dormant oils are available commercially and generally comprise refined petroleum oils or mineral oils having an emulsifier added to allow the oil to be mixed with water. A few commercially available dormant oils are made from vegetable oils such as cottonseed oil and/or soybean oil. As used herein the term “dormant oil” is intended to include both mineral oils and vegetable oils. Particularly preferred as dormant oils are mineral oils and soybean oils. Hop extracts have been known to be effective against mildew and certain (gram positive) bacterial infections, and mites. However, when dormant oil and hop extract are applied together as a spray, the combination unexpectedly provides several additional effects including freeze damage, effective protection against bacterium such as Fire Blight, protection against Codling Moth, Leafroller, Pear Psylla, White Apple Leafhopper, Green Apple Aphid and Wooley Apple Aphid infestations, and protection against fungi such as powdery mildew, downy mildew Cladosporium Cucumerinum (Gamosis) and wilt. Application as a wash throughout the growing season also results in an increase in sugar Brix in fruit allowing earlier harvest of treated fruit.

In addition to acting to suffocate over-wintering pests, the dormant oil also acts as a carrier for the oily components of the hop extract, helping to better disperse the water insoluble components of the hop extract in the wash. The hop extract and dormant oil typically are in volume ratios in a range of about 1 to about 10 extract to oil, preferably a range of about 1 to about 5 extract to oil. In a preferred embodiment of the invention, the volume ratio is about 1-2.7 extract to oil.

In a preferred embodiment of the invention, one or more additional ingredients have been found to positively affect the outcome. These include kelp which in the past has been used as a fertilizer and food thickener, molasses, a syrupy food, and yucca extract which in the past has been used as a foaming agent. Yucca extract is added primarily as a spreader-sticker, and in particular to aid in the sticking of the wash to the plants.

Kelp and molasses also function as spreader-stickers, and all three added ingredients are believed also to contribute to the above-mentioned effects.

The wash also advantageously may be employed as a wash for harvested fruit. Accordingly, as used herein, the term “plant wash” is intended to include a wash as applied to growing plants as well as to harvested fruit and vegetables.

The plant wash typically is in concentrated form, and then diluted with water just prior to application. Typically the wash is applied diluted at a rate of about 0.25 to about 2.0 gallons per acre, based on the concentrated mixture, preferably about 0.5 to about 0.8 gallons per acre based on the concentrated mixture, more preferably about 0.625 gallons per acre, based on the concentrated mixture. The mixture may be further diluted when applied as a bath or spray to harvested fruit or vegetables.

Further features and advantages of the invention will be seen from the following working examples:

### EXAMPLE I

A plant wash concentrate was prepared by mixing together the following ingredients:
Ingredient Per Container
Kelp—6 oz. (dry)
Dormant Mineral
Oil—1 Quart
Hop Extract—12 oz.
Molasses—16 oz.
Yucca Extract—16 oz.
Add water to make 2.5 gal.

All ingredients are mixed together watin (100° F. to 120° F.) and packaged in 2.5 gallon airtight containers.

The resulting concentrate was diluted to 400 gallons with water and applied as a spray to cherry trees in the spring at a rate of 2.5 gallons per four (4) acres. The trees were sprayed every fourteen (14) days through the growing season, beginning when the trees first started to bud. A grove of cherry trees in the adjacent field was untreated. The following was observed:
During spring cold weather nighttime temperatures dropped to 17° F., trees which were untreated exhibited total loss of buds and blossoms. Trees treated with the wash had significantly reduced loss of buds or blossoms. The grove of cherry trees treated with tree wash harvested 10 tons/acre, while the untreated trees in the adjacent grove had a total loss and harvested nothing.

### EXAMPLE II

A tree wash concentrate was prepared as in Example I, diluted to 400 gallons with water, and applied as a spray to apple trees in the spring at a rate of 2.5 gallons per four (4) acres. The trees were sprayed every fourteen (14) days through the growing season, beginning when the trees first started to bud. A grove of apple trees in the adjacent filed was untreated. The following was observed
Fruit was tested as the fruit ripened. The apple orchard which was treated with the tree wash exhibited on average about 14.0 to 14.5% sugar Brix, while the untreated apple orchard in the adjacent filed exhibited on average about 12% sugar Brix, or about 15 to 20% less sugar. Additionally, the apples on trees treated with the wash were found to mature at about the same time permitting a single harvest. Apples on the trees in the adjacent untreated grove matured more slowly, and erratically, requiring that the field be picked twice.
Gamosis—Trees treated with above tree wash were also found to be less susceptible to Gamosis than untreated trees in the adjacent grove.
Codling Moth—Fruit harvested from trees treated with the above wash were found to be free of Codling Moth infestation while fruit from untreated trees in the adjacent grove were found to have larvae or worms in the fruit.

### EXAMPLE III

A tree wash concentrate was prepared as in Example Ito which was added 12 oz. of Entrust, available from Dow AgroSciences, Indianapolis, Ind., USA. The concentrate was diluted to 400 gallons with water, and apple trees in a test grove were treated as in Example II. An adjacent grove was treated with Entrust only at the same application rate. Fruit harvested from trees in the test grove were found to be completely free of Codling Moth infestation while fruit harvested from trees treated only with Entrust showed occasional Codling Moth damage.

### EXAMPLE V

80 oz. of the tree wash concentrate as prepared in Example I was diluted in 100 gallons of water and sprayed on an acre of trees every ten to fourteen days for Fire Blight control. No Fire Blight infestation was observed. This was unexpected since Fire Blight is a gram negative bacteria, while hop extract heretofore was not considered to be effective against gram negative bacteria. The reason for this startling discovery is not known, but is believed to be as a result of a not yet understood synergy between the hop extract and dormant oil, and possibly also one or more of the other ingredients in the wash.

### EXAMPLE V

Two gallons of the tree wash concentrate as prepared in Example I was diluted in 400 gallons of water together with two gallons of ProNatural™Calcium (calcium oxide) available from Wil-Gro Professional Products, Fresno, Calif.

The resulting diluted was then sprayed at a rate of 100 gallons/acre on apple trees as in Example II. Similar results were observed.

### EXAMPLE VI

A plant wash concentrate prepared by mixing together the following ingredients;
Ingredient Per Container
Kelp—12 oz. (dry)
Dormant Oil—32 oz.
Hop Extract—12 oz.
Molasses—16 oz.
Yucca Extract—8 oz.
Add water to make 2.5 gal.

All ingredients are mixed together warm (100° F. to 120° F.) and packaged in 2.5 gallon airtight containers.

Two gallons of the resulting wash concentrate plus two gallons of ProNatural Calcium (calcium oxide) available from Wil-Gro Professional Products, Fresno, CA were mixed together in 400 gallons of water.

The resulting diluted wash was then sprayed at a rate of 100 gallons/acre on apple trees as in Example II. Similar results were observed.

### EXAMPLE VII

A tree wash concentrate was prepared as in Example I, but employing one quart of soybean oil in place of the dormant mineral oil.

Two gallons of the resulting concentrate was diluted in 400 gallons of water, and sprayed at a rate of 100 gallons/acre on apple trees as in Example II. Similar results were observed.

### EXAMPLE VIII

Freshly harvested pears from crop 2009 from California were taken from bins and dipped into a 1:400 dilution of the concentrated wash as prepared in Example VII. Two small bins of treated and un-treated pears were cold stored and observed over two months Photographs were taken (FIGS. 1A-1H), and the following observations were recorded:
Observations—time line:
   8th of August 2009
      Project start—two small bins of un-treated and treated pears were stored in cold storage warehouse.
   13th of August 2009
      Pictures were taken to document the initial quality of the pears
   2nd of September 2009
      No significant differences were noticeable between treated and untreated pears.
      Untreated pears seemed to have a slightly duller appearance upon close inspection, possibly signs of early mould growth when inspected with a hand lens.
   9th of October 2009
      Significant differences were seen between the treated and untreated pears. The bins with the untreated pears showed more fruit with brown spots and clearly visible mold.

While the invention has been described by way of example and in terms of a preferred embodiment, it is to be understood that the invention is not limited to the disclosed embodiments. For example, the wash may be applied to harvested fruit or vegetables by spraying. It is thus intended to cover various modifications and similar arrangements as would be apparent to those skilled in the art. Therefore, the scope of the appended claims should be accorded the broadest interpretation so as to encompass all such modifications and similar arrangements.

What is claimed is:

1. A plant wash comprising a mixture of dormant oil and hop extract.

2. The plant wash of claim 1, wherein the dormant oil comprises a mineral oil.

3. The plant wash of claim 1, wherein the dormant oil comprises a vegetable oil

4. The plant wash of claim 1, wherein the dormant oil comprises soybean oil.

5. The plant wash of claim 1, diluted in a carrier.

6. The plant wash of claim 5, wherein the carrier comprises water.

7. The plant wash of claim 1, wherein the hop extract and dormant oil are in volume ratios in a range of about 1 to about 10 extract to oil.

8. The plant wash of claim 1, wherein the extract and dormant oil are in volume ratios in a range of about 1 to about 5 extract to oil.

9. The plant wash of claim 1, wherein the extract and dormant oil are in a volume ratio of 1-2.7 extract to oil.

10. The plant wash of claim 1, further comprising one or more added ingredients selected from the group consisting of kelp, molasses, yucca extract and calcium oxide.

11. A method for controlling pests, bacterium and fungus on plants which comprises applying the plant wash of claim 5 to the plant during the growing season.

12. The method of claim 11, wherein the wash is applied every 7-21 days.

13. The method of claim 11, wherein the wash is applied every 14 days.

14. The method of claim 11, wherein the wash is applied to the plants at a rate of about 0.25 to about 2.0 gallons per acre.

15. The method of claim 11, wherein the wash is applied to the plants at a rate of about 0.5 to about 0.8 gallons per acre.

16. The method of claim 11, wherein the wash is applied to the plants at a rate of about 0.625 gallons per acre.

17. The method of claim 11, wherein the bacterium comprises Fire Blight.

18. The method of claim 11, wherein the pests include Codling Moth, Leafroller, Pear Psylla, White Apple Leafhopper, Green Apple Aphid and Wooley Apple Aphid.

19. The method of claim 11, wherein the plant is a fruit tree or vegetable plant.

20. The method of claim 11, wherein the fungus is powdery mildew, downy mildew, Gamosis and wilt.

21. A method of protecting plants against freeze damage which comprises applying the wash of claim 5 to the plant.

22. The method of claim 21, wherein the plant is a fruit tree or vegetable plant.

23. A method for preventing growth of mold and bacterium on harvested fruit and vegetables which comprises applying the plant wash of claim 5 to the plant during the growing season.

24. The method of claim 23, wherein the wash is applied by dipping the harvested fruit or vegetable into the wash.

25. The method of claim 23, wherein the wash is applied by spraying.

26. The method of claim 23, wherein the harvested fruit comprises pears.
